(19) United States
(12) Patent Application Publication
(10) Pub. No.: US 2015/0177676 A1
(43) Pub. Date: Jun. 25, 2015

(54) STRUCTURE OF IMAGE FORMING APPARATUS

(71) Applicant: Junichi MURANO, Saitama (JP)

(72) Inventor: Junichi MURANO, Saitama (JP)

(73) Assignee: RICOH COMPANY, LIMITED, Tokyo (JP)

(21) Appl. No.: 14/576,468

(22) Filed: Dec. 19, 2014

(30) Foreign Application Priority Data
Dec. 25, 2013 (JP) 2013-267067

(51) Int. Cl. G03G 15/00

(52) U.S. Cl. CPC G03G 21/1619

(57) ABSTRACT

A structure of an image forming apparatus includes: a front base and a rear base; a stay member connecting the front base and the rear base; and a side plate having a large mass and supported by the stay member. The stay member is formed into a shape to bear the mass of the side plate with an entire width of the stay member.

### CROSS-REFERENCE TO RELATED APPLICATIONS

The present application claims priority to and incorporates by reference the entire contents of Japanese Patent Application No. 2013-267067 filed in Japan on Dec. 25, 2013.

### BACKGROUND OF THE INVENTION

1. Field of the Invention

The present invention relates to a structure of an image forming apparatus, such as a copier, a facsimile, and a scanner.

2. Description of the Related Art

An outline of a structure I of a conventional image forming apparatus is shown in FIG. 7, and a base portion of the structure 1 is shown in FIG. 8. For the purpose of reducing costs, this image forming apparatus is configured by assembling a front base 2 and a rear base 3 with a right stay 4 and a left stay 5 being screwed thereto. A rear side plate 6 is assembled to the rear base 3, and a rear right frame 7 and a rear left frame 8 are assembled to the rear base 3 and the rear side plate 6 so as to prevent the rear side plate 6 from falling over. A front right frame 9 and a front left frame 10 are assembled to the front base 2, and a front side plate 11 is assembled to the front right frame 9 and the front left frame 10. Then, various stays and/or the like are assembled to the front side plate 11 and the rear side plate 6.

The left stay 5 is fastened to the front base 2 and the rear base 3 as described above, and the left stay 5 is also assembled to the rear side plate 6 and the front left frame 10. Then, the rear left frame 8 is located behind the rear side plate 6 and is assembled to the rear side plate 6 and the rear base 3. Thus, the left stay 5 and the rear left frame 8 are provided on the front side and the rear side of the rear side plate 6, respectively, while being separated by the rear side plate 6.

As illustrated in FIG. 9, a driving unit 12, an electrical system 13 and the like for various units, such as a paper feeding device, a developing device, a photoconductor, a toner supply device, and a waste toner collection device, are assembled to the rear side plate 6, a mass of the rear side plate 6 as a whole increases. However, as the left stay 5 and the rear left frame 8, which act as reinforcements, are provided on the front side and the rear side of the rear side plate 6, respectively, while being separated by the rear side plate 6, there may be a case in which the structure 1 cannot withstand the mass of the rear side plate 6 and is deformed, as illustrated by the dashed line in FIG. 9. Further, to prevent the deformation, a rubber leg 14 has to be provided in the vicinity of an area directly below the rear side plate 6, as illustrated in FIG. 10. Thus, a layout of the rubber legs 14 has also been restricted.

An example of the related art is disclosed in Japanese Patent Application Laid-open No. 2005-31364.

In view of the above, there is a need to provide a structure of an image forming apparatus that is capable of preventing deformation and eliminating a restriction on a layout of an installation location of a leg.

### SUMMARY OF THE INVENTION

It is an object of the present invention to at least partially solve the problems in the conventional technology.

A structure of an image forming apparatus includes: a front base and a rear base; a stay member connecting the front base and the rear base; and a side plate having a large mass and supported by the stay member. The stay member is formed into a shape to bear the mass of the side plate with an entire width of the stay member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view schematically illustrating an image forming apparatus to which one embodiment of the present invention can be applied;

FIG. 2 is a perspective view schematically illustrating a structure that is used in one embodiment of the present invention;

FIG. 3 is a perspective view schematically illustrating the structure that is used in one embodiment of the present invention;

FIG. 4 is a perspective view schematically illustrating a base portion that is used in one embodiment of the present invention;

FIG. 5 is a side view schematically illustrating a stay member that is used in one embodiment of the present invention;

FIG. 6 is a schematic diagram illustrating legs that are used in one embodiment of the present invention;

FIG. 7 is a schematic diagram illustrating a conventional structure;

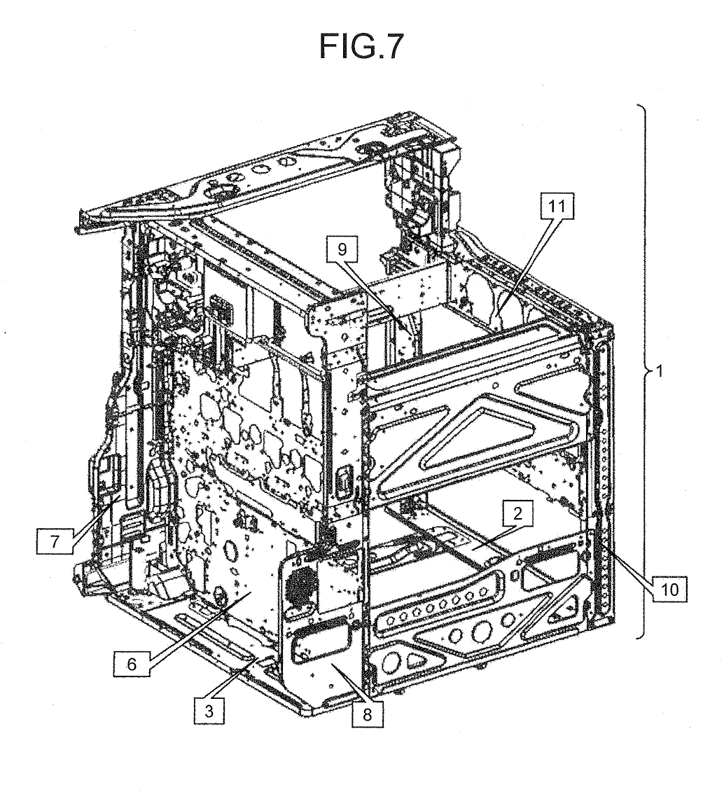

FIG. 8 is a schematic diagram illustrating a conventional base portion;

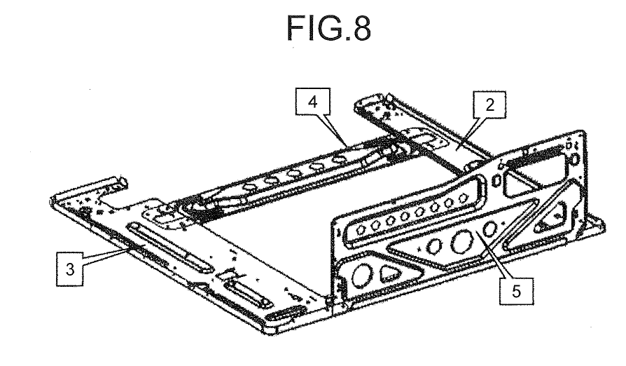

FIG. 9 is a schematic diagram describing a conventional problem; and

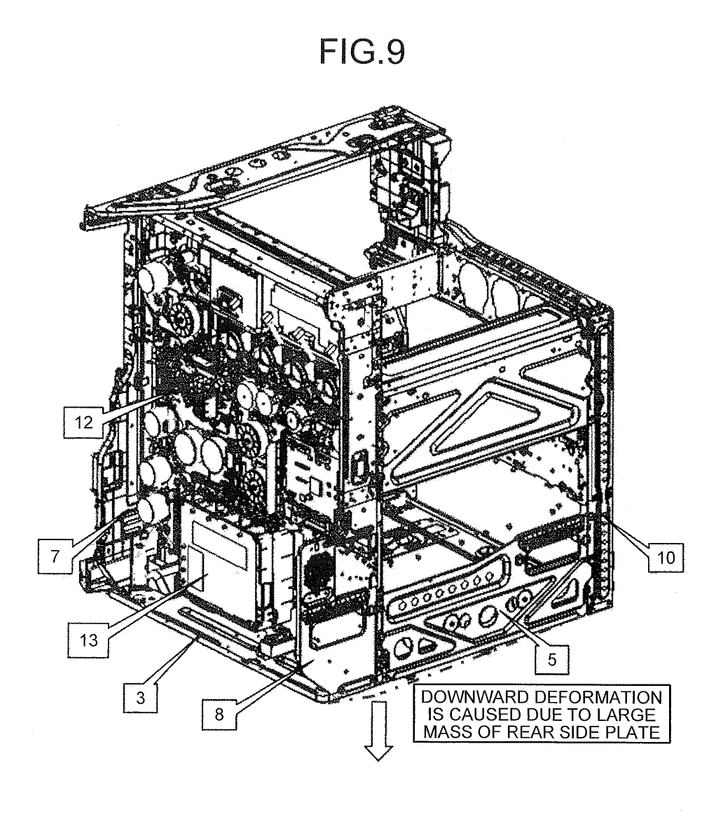

FIG. 10 is a schematic diagram describing the conventional problem.

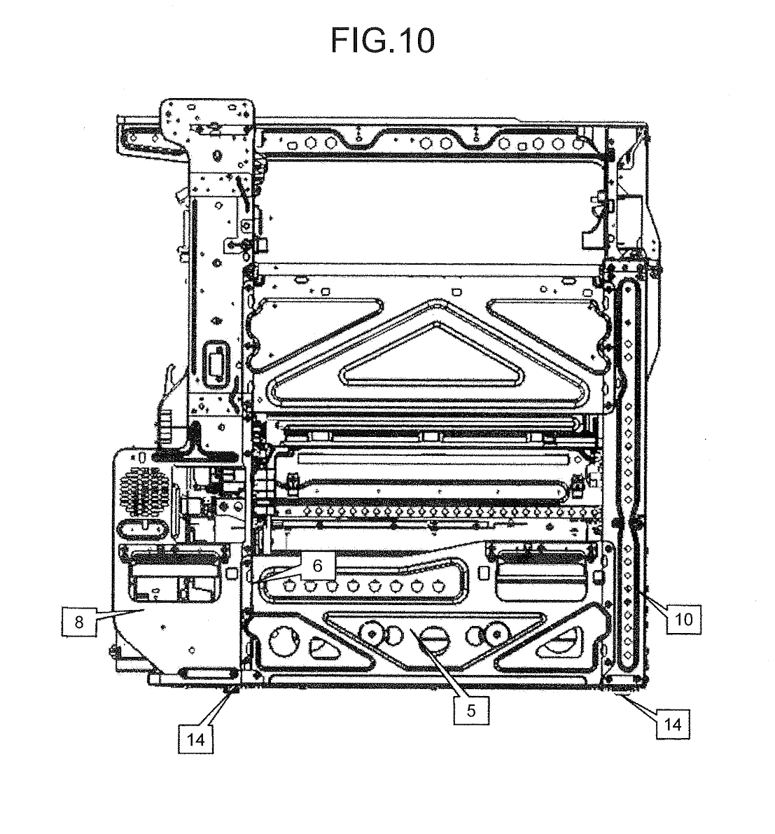

### DETAILED DESCRIPTION OF THE PREFERRED EMBODIMENTS

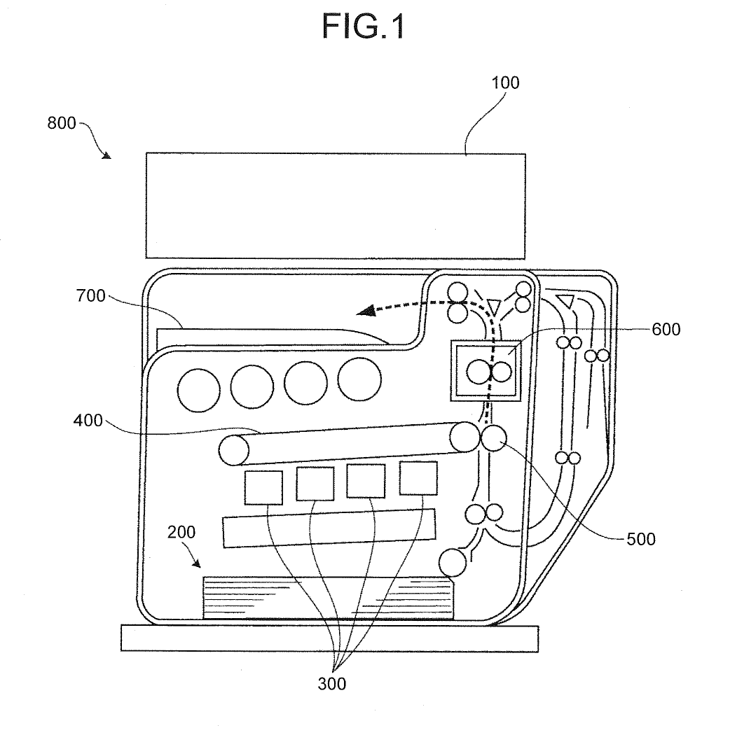

FIG. 1 shows a full color copier that serves as an image forming apparatus to which one embodiment of the present invention can be applied. In FIG. 1, a full color copier 800 develops an image, using an image signal obtained by an image reading portion 100, in an image forming unit 300, wherein the image forming unit 300 is configured by integrating a photoconductor, a charging device, a developing device, a cleaning device, and/or the like, each of which is not shown in the drawings. The developed image is temporarily transferred to an intermediate transfer unit 400 and secondarily transferred by a secondary transfer roller 500 to a transfer paper, which is not shown in the drawings and is conveyed from a paper feeding device 200. Then, the transfer paper, to which the image has been transferred, is conveyed to a fixing device 600, and, after the image is fixed on the transfer paper, ejected to a paper ejection tray 700.

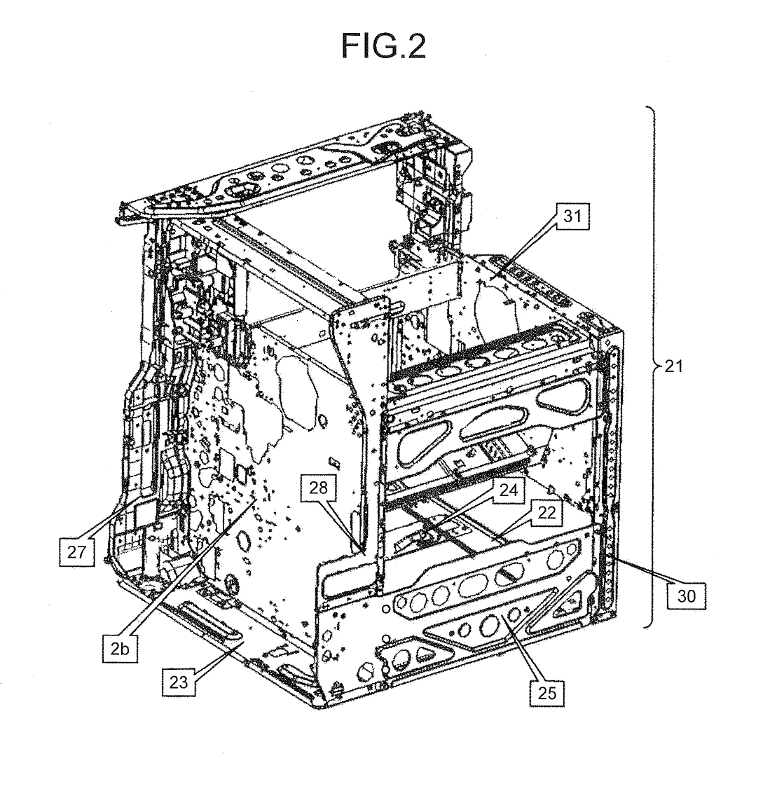

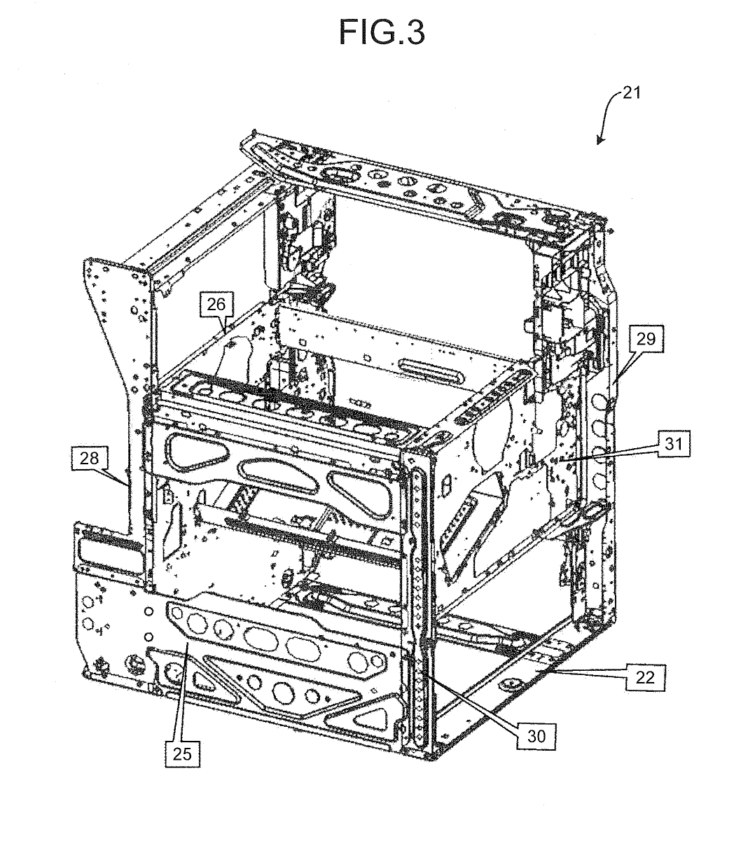

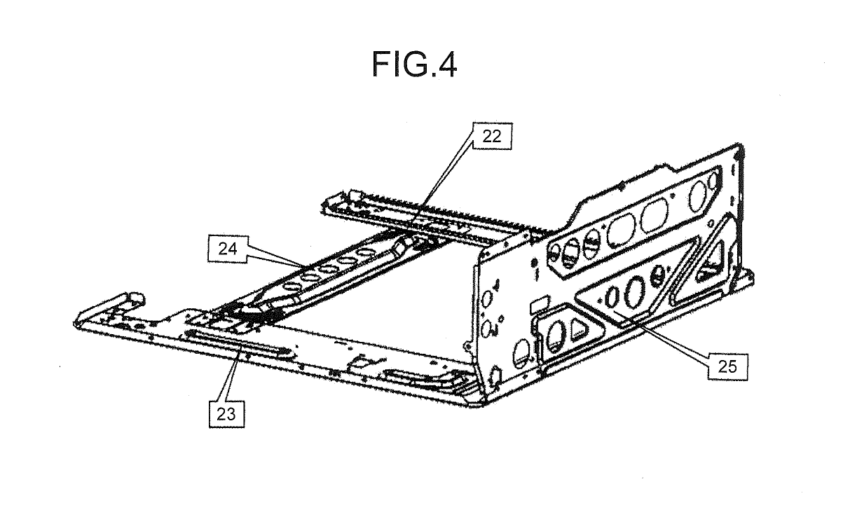

FIG. 2 shows a perspective view of a device main body 21 that is a structure of the full color copier 800 as seen from the rear left, and FIG. 3 shows a perspective view of the device main body 21 as seen from the front left. Further, FIG. 4 shows a base portion that forms a bottom portion of the device main body 21. As illustrated in FIG. 4, as in a conventional device, for the purpose of reducing costs, the full color copier 800 is also configured by assembling a front base 22 and a rear base 23 with a right stay 24 and a left stay 25 which are each a stay member being screwed thereto.

A rear side plate 26, which is a side plate having a large mass, is fastened to the rear base 23, and a rear right frame 27 is assembled to the rear base 23 and the rear side plate 26 at a rear right side. Further, at a rear left side, a rear left frame 28 is assembled to the left stay 25 and the rear side plate 26. Then, as illustrated in FIG. 2, the rear side plate 26 is assembled to the left stay 25 so as to be positioned at the middle of the left stay 25, and the rear base 23 is assembled to the rear side plate 26. In FIG. 2 and FIG. 3, the reference numeral 29 denotes a front right frame that is fastened to the front base 22, the reference numeral 30 denotes a front left frame that is fastened to the front base 22, and the reference numeral 31 denotes a front side plate that is assembled to the front right frame 29 and the front left frame 30.

With the above-described configuration, the rear side plate 26 is positioned at the middle of the left stay 25 and the left stay 25 bears a mass of the rear side plate 26 across the entire width of the left stay 25. Thus, even when a large load is applied to the rear side plate 26, the base portion does not deform significantly. As a result, deformation of the device main body 21 can be prevented.

Further, as illustrated in FIG. 4, the left stay 25 has a size that extends over a whole area of the rear base 23 in the width direction. The left stay 25 also extends rearward behind the rear side plate 26 as far as the layout is possible and is formed so that the total width of the left stay 25 is equal to a length of the image forming apparatus in the depth direction. With this configuration, fastening points between the left stay 25 and the rear base 23 can be increased, and consequently, the deformation of the device main body 21 can be prevented even more effectively.

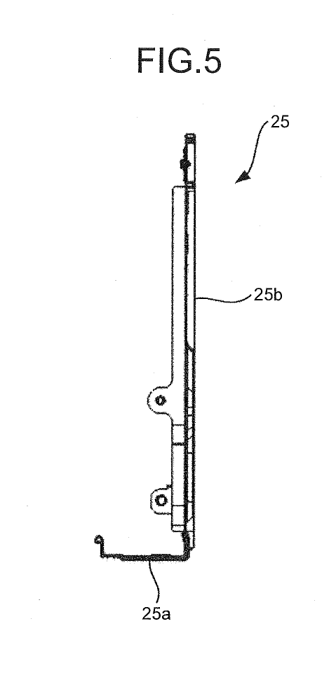

Further, in a side view as seen from the rear side plate 26 side, the left stay 25 has an L-shape, as illustrated in FIG. 5. With this, a bottom portion 25a is assembled to the front base 22, the rear base 23, and the rear side plate 26 as described above, and a side portion 25b is also fixed by the rear side plate 26 and the front left frame 30 from the lateral direction thereof. With this configuration, the left stay 25 is not only fixed to the front base 22 and the rear base 23, but can also be fastened to the rear side plate 26 and other frames from the lateral direction thereof. As a result, the deformation of the device main body 21 can be prevented even more effectively, and also, it is possible to prevent the front side plate 31 and the rear side plate 26 from falling over.

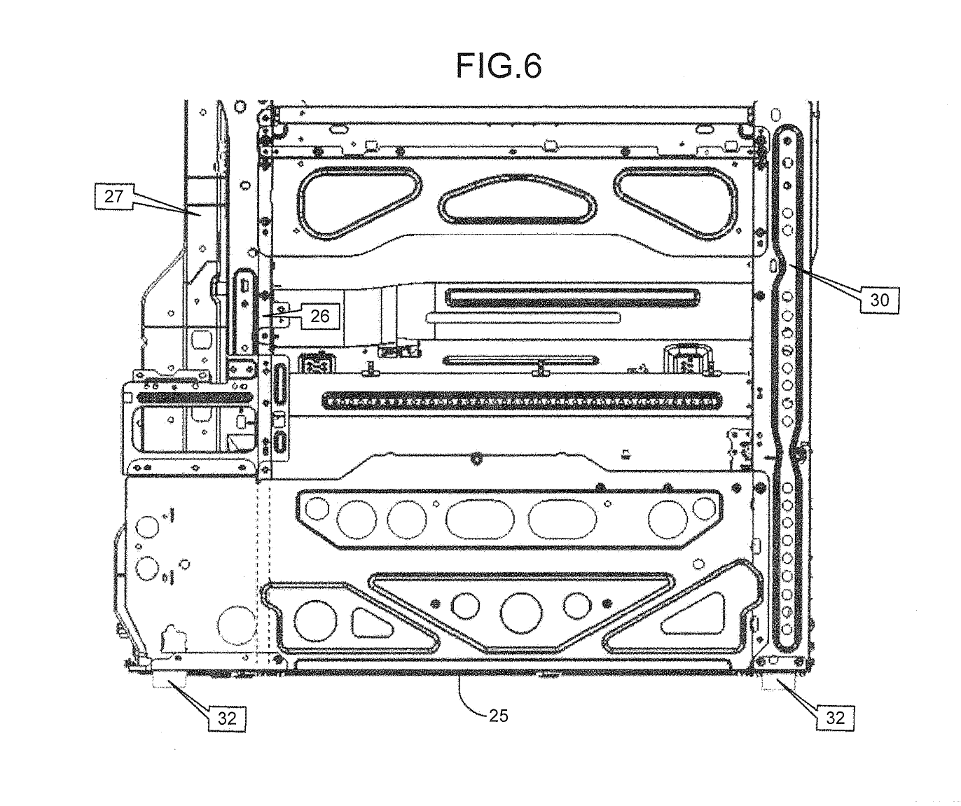

Further, below the left stay 25, legs 32 are assembled as a retaining member, as illustrated in FIG. 6. With this configuration, a restriction on a layout for installation locations of the legs 32 is eliminated as compared with the conventional device. Then, a gap between the front and rear legs 32 can be made as wide as possible, and consequently, it becomes possible to retain the device main body 21 in a stable state.

Although a preferred embodiment of the present invention is described above, the present invention is not limited to the above-described specific embodiment. Various modifications and variations can be made to the present invention within the spirit and scope of the present invention described in the claims, unless otherwise specified in the description above.

For example, an image forming apparatus to which the present invention is applied is not limited to an image forming apparatus of the above-described type, but may be an image forming apparatus of any other type. More specifically, the image forming apparatus to which the present invention is applied may be a stand-alone printer, a stand-alone facsimile, a multifunction peripheral combining a printer and a facsimile, or a multifunction peripheral, such as a monochrome device relating to a printer and a facsimile. Further, the image forming apparatus to which the present invention is applied may also be an image forming apparatus that is used for forming electric circuits or an image forming apparatus that is used for forming a predetermined image in the field of biotechnology.

Effects described above in the embodiment of the present invention are merely a list of most preferred effects arising from the present invention, and the effects of the present invention are not limited to those described in the embodiment of the present invention.

According to an embodiment, the side plate is positioned at a middle of the stay member and the stay member bears the mass of the side plate across the entire width of the stay member. Thus, even when a heavy load is applied to the side plate, the base portion does not deform significantly and deformation of the structure can be prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A structure of an image forming apparatus, comprising:
a front base and a rear base;
a stay member connecting the front base and the rear base; and
a side plate having a large mass and supported by the stay member, wherein
the stay member is formed into a shape to bear the mass of the side plate with an entire width of the stay member.

2. The structure of the image forming apparatus according to claim I, wherein the stay member is formed such that the entire width thereof is equal to a length of the image forming apparatus in a depth direction thereof.

3. The structure of the image forming apparatus according to claim 1, wherein the stay member has an L-shape.

4. The structure of the image forming apparatus according to claim 1, wherein a retaining member is provided at a lower portion of the stay member.
